(19) United States
(12) Patent Application Publication
(10) Pub. No.: US 2011/0232708 A1
(43) Pub. Date: Sep. 29, 2011

(54) Walker and wheel assembly

(76) Inventor: James Martin Kemp, Libertyville, IL (US)

(21) Appl. No.: 13/070,827

(22) Filed: Mar. 24, 2011

Related U.S. Application Data
(60) Provisional application No. 61/316,852, filed on Mar. 24, 2010.

(51) Int. Cl. A61H 3/04; B60B 33/00

(52) U.S. Cl. 135/67; 16/47

(57) ABSTRACT

A walker having a frame and wheel system for use indoors or outdoors, with a wheel assemblies allowing for maintaining substantially level performance over uneven surfaces or obstacles. The wheel assembly includes four wheels in a triple pivot, dual offset configuration. With three pivots and the offset axle configuration, the wheel assemblies allow for substantially even contact with all four wheels of the assembly, with weight substantially balanced on each of the four wheels, during use over uneven surfaces, obstacles, or irregularities.

This application is related to and claims the benefit of U.S. Provisional patent application Ser. No. 61/316852 that was filed on Mar. 24, 2010, which is incorporated herein by reference.

### BACKGROUND

The present invention generally relates to walkers and other wheeled devices. More specifically, the present invention relates to improvements in wheel assembles, which assist in traversing obstacles and uneven surfaces.

There are a growing number of citizens that need the assistance of a walker. As this group of people move about, they will encounter irregularities in the terrain such as door thresholds, area carpets, abrupt floor height transitions, cracks in sidewalks, driveways, curbs/gutters, and streets. Parking lots often accumulate debris such as stones, sticks, and other obstacles that can block the wheel and cause an interruption to the forward progress of the walker. Many of these obstacles are overlooked as the users focus more on the physical movement and support of their bodies. Under these situations, there can be a significant risk of an imbalance or even a fall.

Typical walker designs, as depicted in U.S. Pat. No. 4,135,535, U.S. Pat. No. 4,765,355, U.S. Pat. No. 5,020,560, and U.S. Pat. No. 6,068,273, do not address the issue of obstacles or uneven surfaces. Other references attempt to address obstacles and uneven surfaces, albeit unsuccessfully.

U.S. Pat. No. 6,666,222 B1 to Fattahi et al. (hereinafter ‘Fattahi’) is directed to a rolling walker adapted to negotiate uneven surfaces. Fattahi discloses two wheels on each of the front legs of the walker, using a larger intermediate wheel (Fattahi FIG. 1). By making the low point of this intermediate wheel lower that the low point of the leading wheel (Fattahi col 2, ln 8-11). Fattahi allows the walker to roll over certain obstacles. However, Fattahi suffers from one or more of the handle's grip height being abruptly raised upward when a wheel rolls over an obstacle. Fattahi also suffers from not being able to maintain a substantially level profile of the walker grip height. For instance, when a wheel rolls through a drop or depression, the result is a corresponding drop in grip height. Therefore, Fattahi does not adequately address the hazards that a number of users would still face.

U.S. Pat. No. 6,609,719 B2 to Heien (hereinafter ‘Heien’) is another reference directed to a walker, which unsuccessfully attempts to address obstacles and uneven surfaces. Heien discloses a wheel assembly with a primary wheel and four secondary wheels arranged on the primary wheel (Heien FIG. 1 and FIG. 2), wherein the secondary wheels are to allow for traversing of some obstacles. Because this system utilizes a fixed primary wheel, Heien suffers from the same problems as Fattahi. The walker grips are likely to raise abruptly when a wheel comes into contact and rolls over an obstacle. Similarly, the walker grips are likely to drop abruptly when the leading wheel enters a surface depression, leading to hazardous conditions for walker users.

### SUMMARY

In order to better address obstacles or uneven surfaces, one form of the invention utilizes one or more wheel assemblies, wherein each wheel assembly has offset, multi-tracked wheels, wherein the multiple tracks move with respect to the walker with three pivots.

The three pivots allow a walker to more effectively negotiate obstacles and other surface conditions, than a typical walker. More specifically, the three pivots allow for a smaller variance in walker grip height compared to the prior art walkers, when the wheels come into contact and roll over an obstacle or an uneven surface.

With the addition of the offset wheel configuration, the walker further allows for the downward force of the walker to be better distributed among the wheels compared to the prior art walkers. Each wheel travels on its own path, resulting in improved stability over the prior art.

Because of these improvements, the resulting impedance to forward motion is reduced. Additionally, the decrease in grip height variance over the prior art helps provide for a more stable use of the walker. Finally, the multiple wheel tracks provide lateral stability to lessen the chance of tipping over the prior art. Therefore, the walker reduces the chance of falls and instills confidence in walker users.

### BRIEF DESCRIPTION OF THE DRAWINGS

FIG. 1 is a perspective view of one form of the walker described herein;

FIG. 2 is an enlarged perspective view of the wheel assembly of the walker in FIG. 1;

FIG. 3 is a front perspective view of a radial cross-section of a wheel of the wheel assembly in FIG. 2;

FIG. 4 is an exploded perspective view of the wheel assembly in FIG. 2 and its component parts;

FIG. 5 is an enlarged top plan view of the central hub of the wheel assembly in FIG. 2;

FIG. 6 is an enlarged top plan view of a form of the wheel assembly in FIG. 2;

FIGS. 7A, 7B, 7C are side views of the wheels of the wheel assembly in FIG. 2 as the wheels encounter, traverse, and leave an obstacle or uneven surface condition; and

FIG. 8 is a perspective view of an alternative form of a wheel assembly, utilizing a central hub of an alternate form.

### DETAILED DESCRIPTION

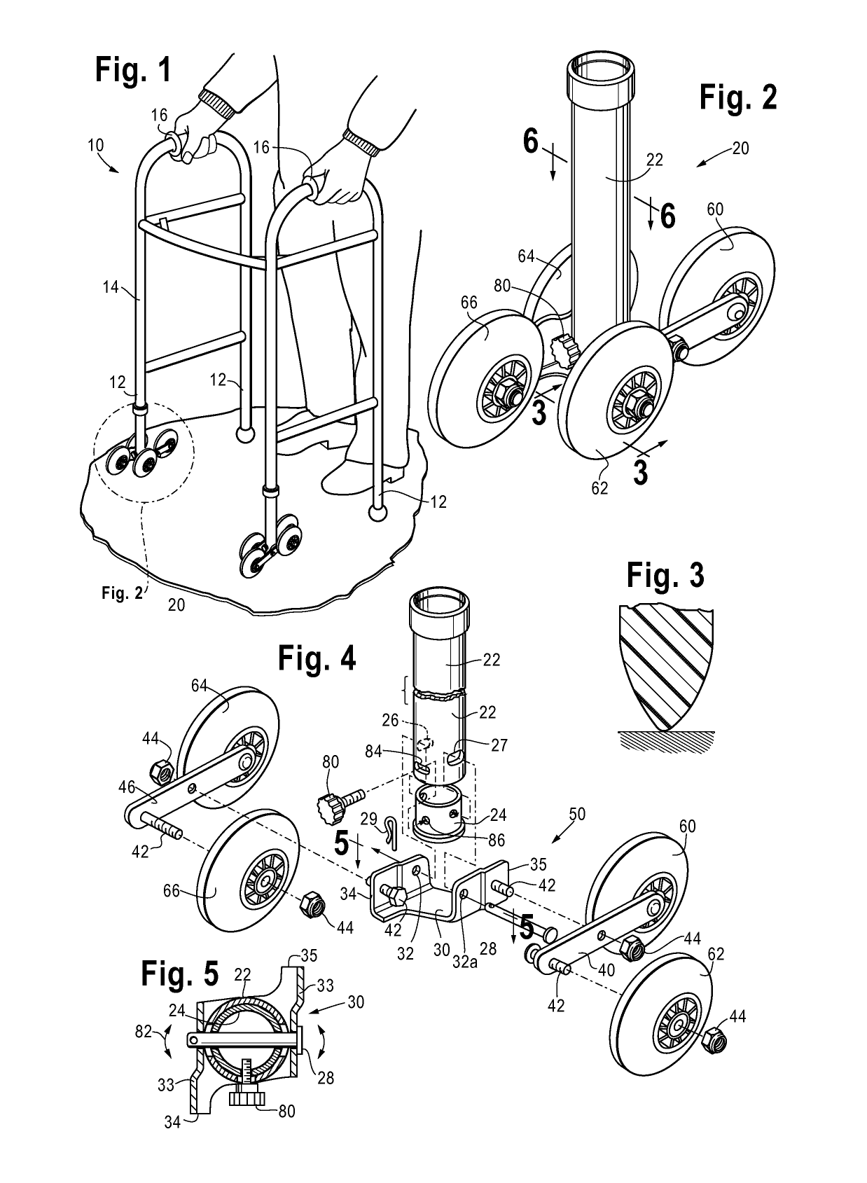

FIG. 1 illustrates one form of the walker. The walker 10 includes a frame, which includes various support sections, such as a-shaped side members 14 with legs 12 and horizontal supports with hand grips 16. Two wheel assemblies 20 are located on the front and bottom of the walker 10. each wheel assembly 20 can be connected to a front leg 12 of the walker 10.

Referring to FIG. 2, the wheel assembly 20 attaches TO a walker leg through a hollow post 22, the hollow post 22 extending upward from the wheel assembly 20 and connecting to the walker leg 12 (FIG. 1). The hollow post can be connected and secured to the walker leg by any suitable device, for example through use of a typical spring-biasing pin (not shown) that is secured within one of several openings (not shown) to allow for height adjustment.

Referring to FIGS. 4 and 5, an end cap 24 slidably mounts into the lower end of the post 22. Apertures 26 and 27 run laterally through both the lower end of the post 22 and the mounted end cap 24. The openings of the apertures 26 and 27 on both the post 22 and the end cap 24 are elongated horizontally. The apertures 26 and 27 allow for slidable placement of a rod 28 through both the end cap 24 and the post 22. The post 22 further includes an adjuster, such as a knob screw 80 which runs through the post 22 and into a wall of the end cap 24, thereby allowing for the end cap 24 to be secured within the post 22. The knob screw 80 in conjunction with the horizontally elongated aperture openings on the post 22 further allow for adjusting the rotational alignment of the rod 28 and wheel assembly with respect to the walker 10 (FIG. 1). Because of the elongated shape of the apertures 26 and 27, the rod 28 and end cap 24 can rotate with respect to the post 22, which allows for adjustment of the toe of the wheels, the adjustment secured by the knob screw 80. As shown in FIG. 5, by loosening the knob screw 80, the central hub 30 through its connection with the end cap 24 can be rotated to an optimal position, thereby effectuating toe alignment adjustment 82.

Referring to FIGS. 4 and 5, a central hub 30 is pivotally connected to the bottom of the post 22. The central hub 30 can be in the form of a stamped bracket as depicted in FIG. 4. The central huh can be of other similarly suitable forms, not limited to molded, machined, cast, or die cast versions of the bracket depicted in FIG. 4. Holes 32, 32A on either side of the central hub 30, allow for the rod 28 to slide through one side of the central hub 30, then through the post 22 and end cap 24, and finally through the other side of the central hub 30. The rod 28 can be secured by securing device such as retaining clip or a cotter pin 29 as depicted in FIG. 4. The central hub 30 pivots about the rod 28 and the lower end of the post 22.

Referring to FIG. 5, the central hub 30 has a rhomboid shape 33. The rhomboid shape 33 allows for offset connections of a first arm 46 and a second arm 40, as seen in FIG. 4. The offset connections allow for the wheels 60 and 66 (FIG. 4) to be extended further from the post 22, which increases the pivoting range of the arms 40 and 46 and the central hub 30 about the post 22, the pivoting range limited by wheels 60 and 66 coming into contact with the post 22. With an increased pivoting range, the walker can traverse surfaces having greater vertical contours.

The first arm 46 (FIG. 4) pivotally connects to the more forward edge 34 of the central hub 50, and a second arm 40 pivotally connects to the more rearward edge 35 of the central hub 30. Both connections can be accomplished with any suitable fastener, such as a bolt 42 and nut 44, connected through apertures near the ends of both the first arm 46 and the second arm 40. The offset configuration 50 shows the first arm 46 being more forward than the second arm 40. Both the first arm 46 and the second arm 40 have a longitudinal orientation, wherein longitudinal is defined as being in the direction of normal travel of the wheels as they roll forward or backward. The first arm 46 and the second arm 40 pivot about their respective pivotal connections, with vertical movement supplied by the pivoting central hub 30.

Unlike a typical walker wheel assembly, which has one wheel, the wheel assembly 20 has four wheels 60, 62, 64, and 66. Two wheels 64 and 66 are rotatably connected to opposite sides of the first arm 46 as shown in FIG. 4, as opposed to being connected on the same side of the first arm 46. Similarly, wheels 60 and 62 are rotatably connected to opposite side of the second arm 40. Each wheel may be fastened by any suitable device. In another form, wheels can be connected to the same side of an arm. In yet another form, the wheels can be connected so that the wheels of an arm are longitudinally aligned in the direction of travel.

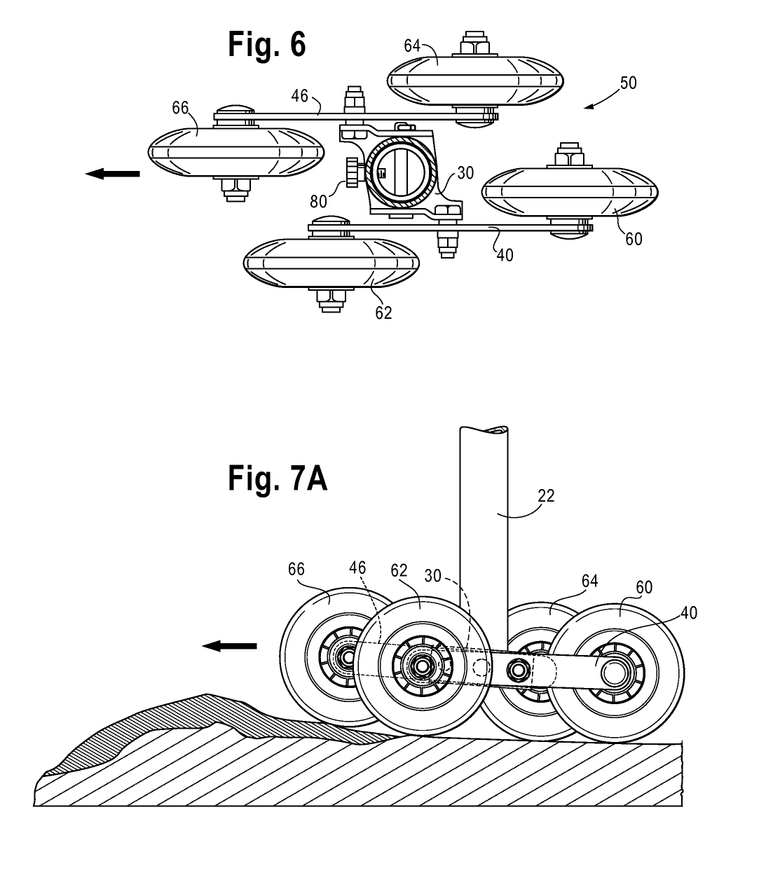

Referring to FIG. 6, the wheels 60, 62, 64, and 66 are offset in two directions. The offset arms 40 and 46 translate a similarly offset longitudinal configuration in the respective wheels. Additionally, because the wheels are mounted on opposite sides of each arm 40 and 46, the wheels 60, 62, 64, and 66 have an offset transverse configuration, wherein transverse is defined as perpendicular to the direction of normal travel of the wheels. As a result of the transverse configuration, each wheel 60, 62, 64, and 66 rolls in a separate path, or track. The offset orientation in two directions, and thus four surface contact points, can allow for greater stability in both the longitudinal and transverse directions and minimize the chance of the walker tipping over. Furthermore, the offset orientation improves the chances that not all of the wheels 60, 62, 64, and 66 will encounter the same obstacle, thereby decreasing the frequency of occurrences where the walker grips would rise up.

The wheels of the wheel assembly 20 can have a narrowed contact edge, or v-shape as show in FIG. 3, wherein the wheel is narrow at the circumference than at the center of the wheel. By reducing the surface contact area, the wheels have an improved chance of avoiding obstacles altogether. Furthermore, a narrower edge profile can lower rolling resistance and can further improve traversing capability over a more standard, flat edged wheel found in typical walkers. However, the wheels can be of any other suitable form, for example wheels that have a flat contact surface or even inflatable wheels.

The wheels of the wheel assembly 20 can be selected based on their suitability for the intended surface. For instance, if more cushion or shock absorption is desired, a more resilient wheel material than what is ordinary found in a typical walker, can be utilized.

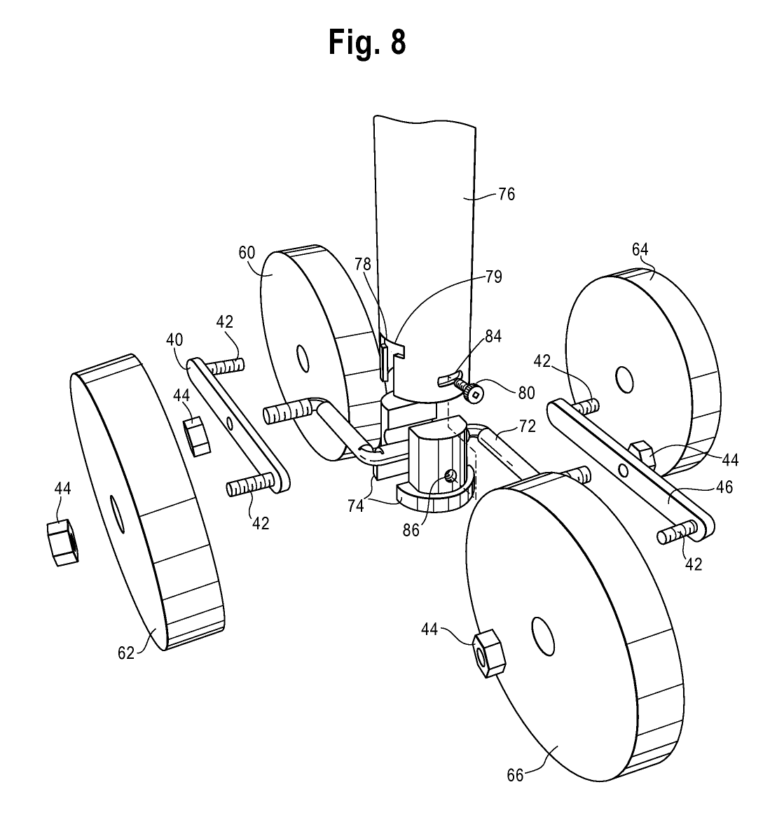

Referring to FIG. 8, while one form of the central hub 30 is shown in FIG. 4, the central hub can be any suitable form that preferably allows for pivoting at the lower end of a walker and pivotal attachment of the arms. For example, in FIG. 8, the central hub can be in the form of a rotating lever 72 without the need for a structural form similar to the stamped bracket shown in FIG. 4. The rotating lever 72 is mounted within a bifurcated end cap 74. the bifurcated end cap 74 which slides into the lower end of the hollow post 76. Due to the difference in mounting the rotating lever 72 from the slidably mounted rod 28 in the form shown in FIG. 4, the post 76 has vertical slots 78 on either side for the rotating lever 72 to move through during mounting of the bifurcated end cap 74 which contains the rotating lever 72. The vertical slots 78 culminate at their respective upper portions with a more horizontally elongated opening 79. The arms 40 and 46 are pivotally connected to opposite ends of the rotating lever 72, but in an offset configuration as shown in FIG. 8.

Because walkers can have slightly differing sizes, tolerances, or precision imperfections in their build quality, a toe alignment problem can result, where the wheels do not run properly in a straight ahead direction. As briefly discussed previously, the central hub 30 and 72, as shown in FIG. 4 and FIG. 8 respectively, allows for rotational, or toe alignment adjustments, through use of an alignment adjustment tightener, for example a knob screw 80, in order to more properly point the wheel assembly 20 in a straight ahead direction. For example, by loosening the knob screw 80 (FIG. 8), which mounts through aperture 84, on post 76, the end cap 74 can be turned to align the wheel assembly. After a suitable alignment has been obtained, the knob screw 80 can be tightened to secure the assembly position.

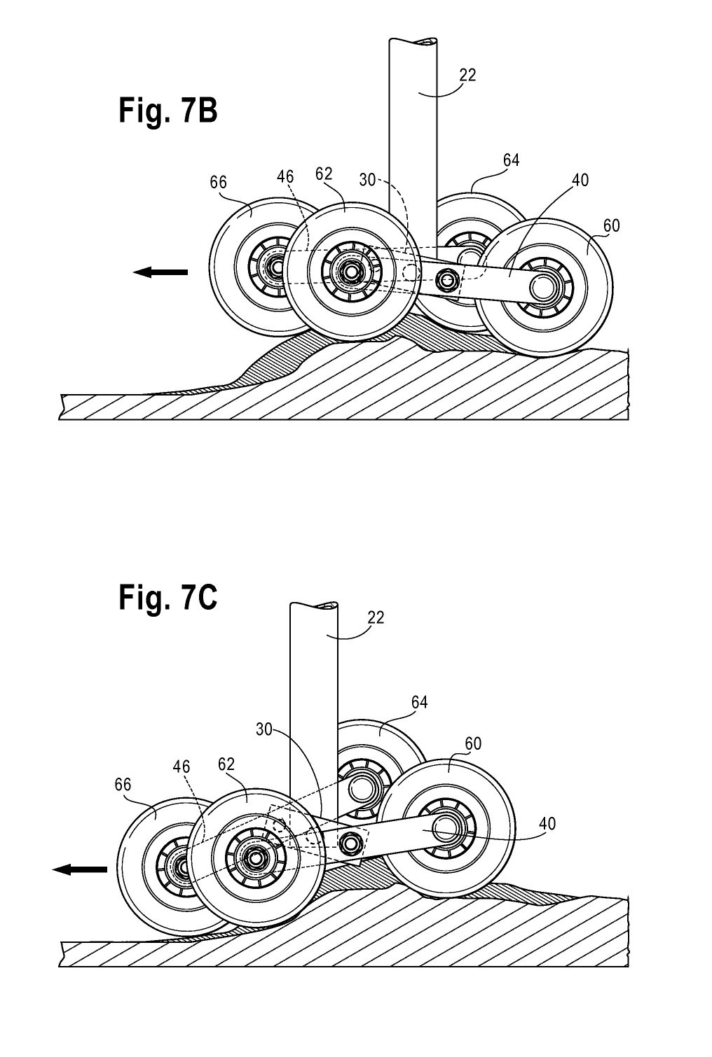

Referring to FIG. 7, the wheel assembly 20 can operate in the following manner. The pivot involving the first arm 46, allows for the front wheel 66 to raise upon contact with an obstacle, while the other three wheels 60, 62, an 64 continue rolling (FIG. 7A). The leading wheel of the second arm 40, which is likely the next wheel in succession, comes into contact with the obstacle (FIG. 7B). Upon this contact, the second arm 40 pivots upward. The pivoting central hub 30 allows for the entire wheel assembly 20 to then tilt upward to further assist in traversing the obstacle, while maintaining level walker grips 16 (FIG. 1). Because the wheel assembly 20 can tilt through the central hub 30, the walker 10 can maintain a more level performance. Also, because the wheel assembly 20 can tilt downward through the central hub 30 (FIG. 7C), the walker 10 allows for more level performance over surface depressions (FIG. 7C).

The wheel assembly 20 thus can allow for each wheel 60, 62, 64, and 66 to remain substantially in contact with the irregular surface, as depicted in FIG. 7A, 7B, and 7C. Additionally, the wheel assembly can reduce the vertical movement sensed by the user of the walker 10 through the handle grips 16. As an added benefit, the downward force exerted by the user of the walker 10 is distributed over four wheels 60, 62, 64, and 66 on each side of the walker 10, resulting in a reduced impedance to forward travel. Furthermore, the multi-tracked assembly (FIG. 6), where each wheel rolls in its own path, transverse (sideways) directions.

While the wheel assembly has been described and depicted for use with a walker 10, the wheel assembly may be applied for other wheeled apparatus where these characteristics would be beneficial, such as child strollers, aerospace, landing gear wheels, ATV's, instrumentation casters, or other applications.

1. A walker comprising:
a frame having a lower end;
at least one wheel assembly coupled to the lower end of the frame;
the wheel assembly having a central hub pivotally connected to the lower end, the connection allowing for the central hub to pivot;
the central hub having a first side and a second side;
a first arm pivotally connected to the first side of the central hub, the first arm having a front end and a back end;
a second arm pivotally connected to the second side of the central hub, the second arm having a front end and a back end;
the first arm and the second arm having an offset configuration, so that the pivotal connection of the first arm is forward of the pivotal connection of the second arm;
a first wheel connected to the front end of the first arm;
a second wheel connected to the back end of the first arm;
a third wheel connected to the front end of the second arm; and
a fourth wheel connected to the back end of the second arm.

2. The walker of claim 1, further comprising:
the first wheel connected, on one side of the first arm, to the front end of the first arm;
the second wheel connected, on the opposite side of the first arm, to the back end of the first arm;
the third wheel connected, on one side of the second arm, to the front end of the second arm; and
the fourth wheel connected, on the opposite side of the second arm, to the back end of the second arm;
so that the first wheel, second wheel, third wheel, and
fourth wheel are offset from one another so that they roll along in separate paths.

3. The walker of claim 2, wherein the wheels have a substantially v-shaped contact surface as seen through a radial cross-section of the wheel, wherein the wheel is narrower at the circumference than at the center of the wheel.

4. The walker of claim 2, wherein the wheels are air inflated wheels, wherein the wheels provide resiliency to improve the ride over uneven surfaces.

5. The walker of claim 2, wherein the walker further comprises an alignment adjustment for adjusting the toe alignment of the wheel assembly.

6. The walker of claim 3, wherein the central hub is a bracket, the bracket pivoting on the walker frame, the bracket further comprising:
apertures on a first side and a second side of the bracket;
a rod slidably mounted through both apertures and through the post of the wheel assembly;
the rod secured by a securing device; and
the bracket pivoting about the rod, the bracket adapted for pivotal connection to the first arm and the second arm.

7. The walker of claim 6, wherein the bracket is a stamped bracket.

8. The walker of claim 6, wherein the securing device is a cotter pin or a retaining clip.

9. The walker of claim 6, wherein the central hub has a rhomboid shape,
the rhomboid shape providing a longitudinal offset configuration, so that the pivotal connection of the first arm is more forward of the pivotal connection of the second arm;

10. The walker of claim 9, wherein the rhomboid shape further limits the upward pivoting range of the first arm and the second arm so that the wheel assembly better maintains contact with surfaces and provides for anti-tipping of the walker in the longitudinal direction.

11. The walker of claim 10, wherein the walker further includes at least the following:
a post adapted for connecting the central hub to the frame;
the post having a bottom end, the bottom end having vertical slots;
the central hub further comprising:
a rotating lever mounted within an end cap;
the rotating lever having two ends, a first end and a second end;
the first end and the second end having a longitudinal offset configuration so that the first end is forward of the second end in the direction of normal travel;
the first end and second end on opposite sides of the central hub;
the first end adapted for pivotal connection of the first arm;
the second end adapted for pivotal connection of the second arm; and
the end cap slidably mounted within the bottom end of the post, so that the end cap containing the rotating lever aligns with the post and the vertical slots provide clearance for the two ends of the rotating lever.

12. A wheel assembly comprising:
a pivoting central hub;
the central hub having a first side and a second side, the first side being, opposite the second side, both sides facing directions that are perpendicular to the direction of normal travel;
at least two arms having a longitudinal orientation, so that the arms point forward and rearward in the direction of travel;
the first arm pivotally connected to the first side of the central hub;
the second arm pivotally connected to the second side of the central hub;
the first arm and the second arm having a longitudinal offset configuration, so that the pivotal connection of the second arm is more forward than the pivotal connection of the first arm;
the first arm having a front end and a back end;
the second arm having a front end and a back end;
a wheel rotatably connected to the front end and back end of each arm, so that the wheel assembly has four wheels; and
the central hub and the two arms operating with three pivotal connections, so that a load is distributed among the four wheels of the wheel assembly, while the wheel assembly negotiates obstacles.

13. The wheel assembly of claim 12, further comprising the wheels connected on opposite sides of each arm, so that the wheels have a transverse offset configuration in addition to the longitudinal offset configuration, so that each wheel travels in a separate line of travel.

14. The wheel assembly of claim 13, further comprising a hollow post connected to the central hub, the hollow post adapted for connection to a walker.

15. The wheel, assembly of claim 13, wherein the wheels are applied to the base of a walker.

16. The wheel assembly of claim 13, wherein the wheels are applied to the base of a stroller.

17. The wheel assembly of claim 13, wherein the wheels are applied to a cart or a table.

18. The wheel assembly of claim 13, wherein the center-line of the wheels are longitudinally equidistant so that the wheel assembly is balanced longitudinally, and so that the wheels have more contact surfaces to further improve the ability of the wheel assembly to roll over obstacles and surface depressions while minimizing vertical displacement of the wheel assembly as a whole.

19. The walker of claim 13, wherein the walker further comprises alignment adjustment for accommodating the wheel assembly to the walker in order to maintain precise straight ahead directional alignment.

20. The walker of claim 14, further comprising:
an end cap adapted to slidably mount to the bottom of the post.

21. A walker having a hand grip, the walker comprising:
a frame with a lower end;
the lower end having at least one wheel assembly pivotally coupled to the frame;
the wheel assembly having at least four wheels;
the wheels pivotally coupled to the wheel assembly; and
the wheels further having a transverse configuration perpendicular to the direction of travel such that each wheel travels in an independent path wherein the pivotal coupling between the assembly and the frame in combination with the pivotal coupling of the wheels limits the abrupt changes in height of a hand grip on the walker.
